(19) United States
(12) Patent Application Publication
(10) Pub. No.: US 2007/0104921 A1
(43) Pub. Date: May 10, 2007

(54) Optical recording medium having a higher crystallization speed

(75) Inventor: Shuichi Ohkubo, Tokyo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC CORPORATION, Tokyo (JP)

(21) Appl. No.: 11/593,565

(22) Filed: Nov. 7, 2006

(30) Foreign Application Priority Data
Nov. 7, 2005 (JP) 2005-321842

(51) Int. Cl. B32B 3/02

(52) U.S. Cl. 428/64.4; 428/64.1

(57) ABSTRACT

A phase change optical disk includes interface films sandwiching therebetween a recording film, wherein the interface films are configured by dielectric films including a mixture of Al oxide, T oxide and Ta oxide. The interface films improve the crystallization speed of the recording film without lowering the crystallizing temperature of the recording film.

### BACKGROUND OF THE INVENTION

(a) Field of the Invention

The present invention relates to an optical recording medium and, more particularly, to an improvement in a crystallization speed of an optical recording medium having a property of changing the optical characteristic thereof upon irradiation of a laser beam.

(b) Description of the Related Art

In general, for recording/reproducing data on a rewritable optical disk, such as magneto-optical disk and phase change optical disk, a laser beam is irradiated onto a recording film in the optical disk to change the optical characteristic of the recording film, such as magneto-optical characteristic, reflectance and optical phase. Optical disks have ever been required to have a higher recording speed, and now achieved a 16-fold-speed recording scheme as in the DVD-R and DVD-RAM. The optical disks are also required to have a larger recording capacity in addition to the higher-speed recording capability.

For increasing the recording capacity of an optical disk, it is effective to record/reproduce data by using a small-diameter laser beam. Thus, vigorous researches have been conducted on the study of optical disks on which the data is recorded/reproduced using a laser beam having a wavelength as small as around 405 nm.

In a phase change optical disk for which a small-diameter laser beam is used, there is a problem that an overwrite process reduces the erasing factor. Erasure of data on the phase change optical disk is performed by crystallizing a recorded mark having an amorphous phase, necessitating the portion of the phase change optical film to be maintained at above the crystallizing temperature for a specific time interval. A smaller diameter of the laser beam reduces the is time length for which the recording film can be maintained at above the crystallizing temperature, which fact incurs an insufficient crystallization of the recording film to thereby cause a malfunction in the erasure of data. This time length is referred to as “hold time” in this text. The hold time is also incurred by a high linear speed of the recording disk, in addition to the afore-mentioned smaller diameter of the laser beam. Thus, for achieving a high-speed recording on the optical disk, it is necessary to realize a recording film having a higher-speed crystallizing property, i.e., a recording film wherein the crystallization is completed in a smaller hold time.

It is generally considered that the improvement in the crystallization speed for the recording film can be achieved by the following technique:

(1) optimizing composition of the recording film to achieve a higher-crystallizing-speed property in the recording film itself; and

(2) providing a crystallization assist film adjacent to the recording film to increase the crystallization speed thereof. The techniques (1) and (2) are described in Patent Publications JP-2003-200665A and 2000-222777, for example.

The technique (1) uses a recording film including Sb as a main component thereof, and additives such as Ge, Ga and Te. The technique (2) provides an interface film, such as including GeN, SiN, HfO₂ and SiC, adjacent to a GeTe—Sb₂Te₃ recording film, wherein the interface film increases the possibility of occurrence of crystallizing cores to thereby reduce the crystallization time length. The interface film also has a function of suppressing diffusion of sulfur from a ZnS—SiO₂ protective film to, improve the iterative overwrite characteristic.

There is a problem in the technique (1), however, that a high-speed crystallization characteristic of the recording film at a temperature in the vicinity of the melting point allows the portion of the recording film once melted at a temperature exceeding the melting point to assume a crystallized phase rather than an amorphous phase after the cool-down of the once-melted portion, thereby preventing formation of a recorded mark. In addition, a higher-speed-crystallization property of the recording film reduces the preservation stability of the recorded mark, whereby the recorded mark may be lost after storing the recorded mark as it is for a long time even in a room temperature.

In a high-speed recording scheme using a blue-violet semiconductor laser, the crystallization time length should be reduced than ever. This recording scheme requires the higher crystallization speed without losing the preservation stability of the recorded mark.

The technique (2), which provides an additional interface film, is insufficient in the improvement of ruction in the crystallization time length, preservation stability of the recorded mark and overwrite characteristic so long as the conventional interface film is used, although a limited reduction in the crystallization time length can be achieved. Thus, the technique (2) is requested to achieve a further improvement.

### SUMMARY OF THE INVENTION

In view of the above problems in the conventional techniques, it is an object of the present invention to provide an optical disk having a higher stability of the recorded mark and suited to a high-speed recording scheme.

The present invention provides an optical recording medium including a substrate, and a layer structure overlying the substrate, the layer structure including: a recording film having a property of changing an optical characteristic upon irradiation of a laser beam; a reflective film for reflecting a laser beam onto the recording film; and a first dielectric film including therein an aluminum oxide, a yttrium oxide and a tantalum oxide.

In accordance with the optical disk of the present invention, the first dielectric film including the mixture of Al oxide, Y oxide and Ta oxide improves the crystallization speed of the recording film without lowering the crystallizing temperature of the recording film, thereby providing an optical recording medium having a higher crystallization speed, achieving a higher preservation stability and suited to a higher recording scheme.

The above and other objects, features and advantages of the present invention will be more apparent from the following description, referring to the accompanying drawings.

### BRIEF DESCRIPTION OF THE DRAWINGS

FIG. 1 is a schematic sectional view of an optical disk according to an embodiment of the present invention.

FIG. 2 is a graph showing the relationship between the linear speed of the optical disk and the erasing factor.

FIG. 3 is a graph showing the relationship between the thickness of the interface film and the number of overwrite times.

### PREFERRED EMBODIMENT OF THE INVENTION

Now, the present invention is more specifically described with reference to accompanying drawings, wherein similar constituent elements are designated by similar reference numerals throughout the drawings.

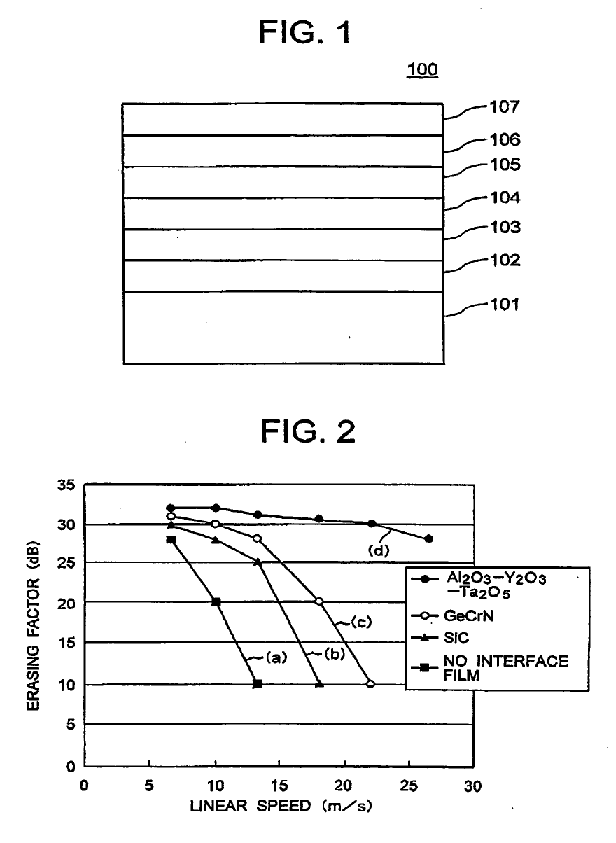

FIG. 1 shows the sectional view of an optical disk according to an embodiment of the present invention; The optical disk, generally designated by numeral 100, includes a substrate 101, and a layer structure formed thereon. The layer structure includes a protective film 102, interface film 103, recording film 104, interface film 105, protective film 106 and reflective film 107, which are deposited on the substrate 101 in this order.

The substrate 101 may be made of a plastic material such as polycarbonate (PC) or a glass material. The protective films 102, 106 and interface films 103, 105 are made of a dielectric material, in general. The protective films 102, 106 may be made of, for example, ZnS—SiO₂, Ta₂O₅, SiN and SiO₂. In the view point of optimum refractive index and overwrite characteristic, ZnS—SiO₂ is more preferable. A most preferable composition of ZnS—SiO₂ is such that x in the molar percent notation of (ZnS)ₓ—(SiO₂)₁₋ₓ resides in the range of 0.5≦x≦0.9.

The interface films 103, 105 are provided in the optical disk for the purpose of improvement in the crystallization speed and a larger number of overwrite times, the interface films including at least aluminum (Al) oxide, yttrium (Y) oxide and tantalum (Ta) oxide. The recording film 104 may be configured as a phase change optical film including GeSbTe or AgInSbTe, for example. A most preferable composition of the recording film 104 is such that u, α, v and w in the molar percent notation of (Ge₁₋ᵤSnᵤTe)_{α}(SbᵥBi_{w}In_{2-v-w}Te₃) reside in the range of 0≦u≦0.5, 5.4≦α≦40, 0≦w≦1.95, and 1.5≦v+w≦1.95. The reflective film 107 preferably includes Ag or Al as the main component thereof. Additive elements, such as Pd, Cu, Ge, In, Nd, Ti, Cr and Ni, may be added to the reflective film 107 for improvement in the atmospheric corrosion resistance thereof.

After a number of experiments for investigating combinations of a variety of materials, it was found that the interface films 103, 105 should be preferably made of a dielectric material including a mixture of Al oxide, Y oxide and Ta oxide as a main component thereof for improvement in the crystallization speed over the conventional interface film, without degrading the number of overwrite times and preservation stability of the recorded mark. Although the interface films 103, 105 should be preferably provided on both surfaces of the recording film 104, a single interface film 103 or 105 may be provided on the recording film Both the interface films 103, 105 need not have a common composition or a common content ratio, and a combination of different compositions or different content ratios may be employed for both the interface films 103, 105.

The interface films 103, 105 including the mixture of Al oxide, Y oxide and Ta oxide may be obtained by sputtering a target configured by a mixture of Al₂O₃, Y₂O₃ and Ta₂O₅, for example. The sputtering process may be conducted in an argon atmosphere or a mixed gas atmosphere including argon and oxygen. The composition of the main component should preferably be such that x and z in the molar percent notation of (Al₂O₃)ₓ(Y₂O3)_{y}(Ta₂O₅)_{z} reside in the range of 20≦z≦60 and 5≦x≦30 for x+y+z=100. This is partly because an excessive amount of Al₂O₃ may degrade the preservation stability of the recorded mark, and an excessive amount of Y₂O₃ or Ta₂O₅ may reduce the number of overwrite time.

In the experiments, the interface films 103, 105 made of (Al₂O₃)—(Ta₂O₅) without including Y₂O₃ revealed that the resultant material did not satisfy all of the desired crystallization speed, preservation stability and overwrite characteristic. The experiments revealed that addition of Y₂O₃ to the mixture of (Al₂O₃)—(Ta₂O₅) provides an interface film satisfying all of the recited characteristics. The interface films 103, 105 may include additive oxides such as bismuth (Bi) oxide, cerium (Ce) oxide, silicon (Si) oxide and/or gadolinium (Gd) oxide, in addition to the main component including the mixture of Al oxide, Y oxide and Ta oxide. The main component should preferably be included in the interface films at a content of 90% or more.

### FIRST EXAMPLE

Samples of the optical disk of the above embodiment were manufactured in a first example, by consecutively depositing the protective film 102, interface film 103, recording film 104, interface film 105, protective film 106 and reflective film 107 by sputtering onto a PC substrate 101, wherein a variety of materials were used in the interface films 103, 105 for different samples. The protective film 102 included ZnS—SiO₂ and was 50 nm thick. The recording film 104 included Ge₁₀Te₁₀—Bi_{1.8}In_{0.2}Te₃ and was 15 nm thick. The protective film 106 included ZnS—SiO₂ and was 15 nm thick. The reflective film 107 included Al—Ti and was 100 nm thick.

In this example, both the interface films 103, 105 in each sample are made of a common material, and the interface films 103, 105 in three different samples are made of different materials for the three different samples including: (Al₂O₃)₂₅—(Y₂O₃)₃₅—(Ta₂O₅)₄₀; GeCrN; and SiC. The interface films 103, 105 were 5 nm thick. A 25-nm-deep spiral groove was formed on the PC substrate 101 for a tracking servo control, and wound at a pitch of 0.4 μm. The resultant samples of the phase change optical disk were subjected to a recording/reproducing test using an optical head including a laser device having an emission wavelength of 405 nm and an objective lens having a numerical aperture of 0.65 for investigating the relationship between the erasing factor and the linear speed of the optical disk. The erasing factor is measured while recording a 1-μm-long mark and erasing the same for each of different linear speeds.

FIG. 2 shows the relationship thus obtained in the first example between the erasing factor and the linear speed. In general, a recording film having a higher-speed-crystallization property provides an erasing factor which is scarcely degraded along with the increase of the linear speed On the other hand, a recording film having a lower-speed-crystallization property provides an erasing factor which is abruptly degraded along with the increase of the linear speed, although the latter recording film provides a relatively higher erasing factor in the range of a lower linear speed. An optical disk having no interface film therein has a lower-speed crystallization property and an erasing factor which is abruptly degraded along with the increase of the linear speed, as shown by the graph (a) in FIG. 2.

The samples including SiC or GeCrN in the interface films 103, 105 had a higher linear speed at which the erasing factor abruptly reduced, as compared to the optical disk including no interface film; however, the erasing factor abruptly reduced in the vicinity of a linear speed of 15 meters per second (m/s), as shown by the graphs (b) and (c). On the other hand, the samples including (Al₂O₃)₂₅—(Y₂O₃)₃₅—(Ta₂O₅)₄₀ in the interface films 103, 105 had a higher erasing factor which did not abruptly reduce along with the increase of the linear speed, as shown by the graph (d) in FIG. 2. This means a considerable improvement in the crystallization speed achieved by the present invention.

### SECOND EXAMPLE

Samples of the second example were manufactured by consecutively depositing the protective film 102, interface film 103, recording film 104, interface film 105, protective film 106 and reflective film 107 by sputtering onto a PC substrate 101, similarly to the first example. In these samples, a variety of compositions were employed for the targets used for sputtering the interface films 103, 105 for different samples. The protective film 102 included ZnS—SiO₂ and was 50 nm thick. The recording film 104 included Ge₁₀Te₁₀—Bi_{1.9}In_{0.1}Te₃ and was 15 nm thick. The protective film 106 included ZnS—SiO₂ and was 15 nm thick. The reflective film 107 included Al—Ti and was 100 nm thick. The interface films 103, 105 included Al₂O₃—Ta₂O₅, and were 5 nm thick.

The resultant samples were subjected to recording of data thereon, and to an environmental test for investigating the relationship between the content ratio and the preservation stability of the recorded mark. The optical head same as to that used in the first example was used herein. 1-7 modulated data were recorded in the recording process by using a linear speed of 26.4 m/s and a clock frequency of 259 MHz. The environmental test was conducted at an ambient temperature of 85 degrees C. and a relative humidity of 90% for a time length of 300 hours. Bit error rate (E.E.) was measured for the optical disks before and after the environmental test, and the results of the measurements are shown in the following Table 1, wherein x, y and z represent the molar percent of the mixture.

TABLE 1

| | E.E. | E.E. |
|---|---|---|
| (Al₂O₃)ₓ(Y₂O₃)_{y}(Ta₂O₅)z | (Before Env. Test) | (After Env. Test) |
| x = 3, y = 77, z = 20 | 5.3 × 10⁻⁴ | 5.1 × 10⁻⁴ |
| x = 5, y = 75, z = 20 | 1 × 10⁻⁴ | 1 × 10⁻⁴ |
| x = 30, y = 50, z = 20 | 3 × 10⁻⁶ | 1 × 10⁻⁵ |
| x = 33, y = 47, z = 20 | 1 × 10⁻⁶ | 2 × 10⁻⁴ |

It will be understood from Table 1 that a lower content ratio (x) of Al₂O₃ provides a degraded bit error rate, although the bit error rate does not significantly changed between before and after the environmental test. This is probably the result of a lower crystallization speed occurring in the case of the lower content ratio of Al₂O₃. On the other hand, a higher content ratio of Al₂O₃ provides a higher crystallization speed and a higher initial bit error rate before the environmental test; however, an excessively higher content ratio of Al₂O₃ as high as 30% or above increases the bit error rate after the environmental test, to thereby degrade the preservation stability of the recorded mark. In view of this, a preferable content ratio of Al₂O₃ resides in the range between 5% and 30% in the interface films 103, 105.

### THIRD EXAMPLE

Samples of the phase change optical disk of the above embodiment were manufactured similarly to the first and second examples, except that the recording film 104 included Ge₆Te₆—Bi_{1.8}In_{0.2}Te₃ and was 15 nm thick. The protective film 106 included ZnS—SiO₂ and was 15 nm thick. The reflective film 107 included Al—Ti and was 100 nm thick. The interface films 103, 105 included Al₂O₃—Y₂O₃—Ta₂O₅, and were 5 nm thick.

The resultant samples were subjected to an iterative overwrite process to investigate the relationship between the content ratio and the number of overwrite times. The optical head used was the same as that used in the first and second examples. The overwrite process was conducted for recording (1-7)-modulated marks at a linear speed of 26.4 m/s and a clock frequency of 259 MHz. The number of overwrite times employed as the property of the samples was defined by the number of overwrite times above which the bit error rate assumed below 1×10⁻¹⁴ for the respective samples. The results of the third example are shown in the following Table 2.

TABLE 2

| (Al₂O₃)ₓ(Y₂O₃)_{y}(Ta2O5)z | Number of Overwrite Times |
|---|---|
| x = 5, y = 80, z = 15 | 800 |
| x = 5, y = 75, z = 20 | 2000 |
| x = 5, y = 45, z = 20 | 3000 |
| x = 5, y = 40, z = 55 | 2000 |
| x = 5, y = 35, z = 60 | 1500 |
| x = 30, y = 55, z = 15 | 800 |
| x = 30, y = 50, z = 20 | 1500 |
| x = 30, y = 20, z = 50 | 2000 |
| x = 30, y = 15, z = 55 | 1500 |
| x = 30, y = 10, z = 60 | 1000 |

As understood from Table 2, the combination of an Al₂O₃ content of 5 to 30% and a Ta₂O₅ content of 20 to 60% provides a number of overwrite times above 1000, thereby proving a preferable overwrite characteristic. In addition, a Ta₂O₅ content of 20 to 50% provides a number of overwrite times over 1500, thereby proving a more preferable overwrite characteristic. Combining the results of the third example with the second example, it was found that x and z in the molar percent notation of the composition (Al₂O₃)ₓ(Y₂O₃)_{y}(Ta₂O₅)_{z} should reside in the range of 5≦x≦30 and 20≦z≦60 for x+y+z=100, in order for achieving a phase change optical disk having a desirable crystallization assist function, a suitable erasing factor at a higher linear speed, and a suitable preservation stability, to thereby realize a phase optical disk having a superior overwrite characteristic.

### FOURTH EXAMPLE

Samples of the optical disk of the above embodiment similar to the above examples were manufactured except that interface film 103 had a variety of thicknesses for the different samples. The protective film 102 included ZnS—SiO₂ and was 50 nm thick. The recording film 104 included Ge₆Te₆—Bi_{1.8}In_{0.2}Te₃ and was 15 nm thick. The protective film 106 included ZnS—SiO₂ and was 15 nm thick.

The reflective film 107 included Al—Ti and was 100 nm thick. The interface films 103, 105 included (Al₂O₃)₂₀(Y₂O₃)₃₅(Ta₂O₅)₄₅, wherein interface film 103 had a variety of thicknesses in the range of 1 to 20 nm for respective samples whereas interface film 105 had a thickness fixed at 5 nm.

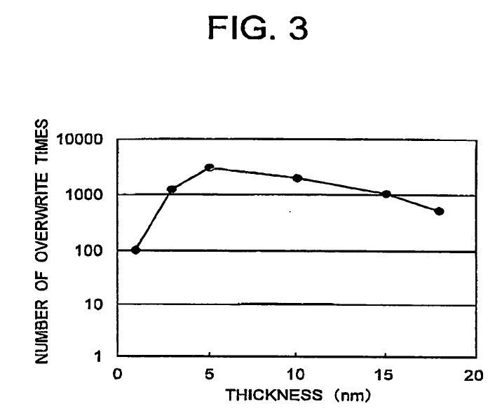

The resultant samples were subjected to an iterative overwrite process to investigate the relationship between the content ratio and the number of overwrite times. The definition and measurement of the overwrite times for the samples were similar to those in the third example. FIG. 3 shows the relationship thus obtained between the thickness of interface film 103 and the number of overwrite times for the samples. As understood from FIG. 3, a thickness of interface film 103 between 3 nm and 15 nm provides a superior number of overwrite times as high as 1000 or above.

### FIFTH EXAMPLE

Samples of the fifth example were similar to those in the first example, and were subjected to investigation of the relationship between the crystallization assist function of the interface films 103, 105 and the composition of the recording film as well as the relationship between the preservation stability of the recorded mark and the composition of the recording film 104. The interface films 103, 105 included (Al₂O₃)₂₅(Y₂O₃)₃₅(Ta₂O₅)₄₀ similarly to the samples of the first example. The presence or absence of the effective crystallization assist function was judged by judging whether or not a DC erasing factor of 30 dB or above was obtained at a linear speed of 26.4 m/s. Pass or fail as to the preservation stability was judged by judging whether or not a bit error rate of 1×10⁻¹⁴ or below could be obtained after an environmental test conducted at an ambient temperature of 80 degrees C. and a relative humidity of 90% for 500 hours. The test results of representative samples in the fifth example are shown in the following Table 3.

TABLE 3

| | Crystallization | Preservation |
|---|---|---|
| (Ge₁₋ᵤSnᵤTe)_{α}(SbᵥBi_{w}In_{2-v-w}Te₃) | Assist Function | Stability |
| u = 0, α = 3, v = w = 0.9 | Pass | Fail |
| u = 0, α = 4, v = w = 0.9 | Pass | Pass |
| u = 0, α = 30, v = w = 0.9 | Pass | Pass |
| u = 0, α = 40, v = w = 0.9 | Pass | Pass |
| u = 0, α = 42, v = w = 0.9 | Fail | — |
| u = 0.3, α = 3, v = w = 0.9 | Pass | Fail |
| u = 0.3, α = 4, v = w = 0.9 | Pass | Pass |
| u = 0.3, α = 30, v = w = 0.9 | Pass | Pass |
| u = 0.3, α = 40, v = w = 0.9 | Pass | Pass |
| u = 0.3, α = 42, v = w = 0.9 | Pass | Fail |
| u = 0.1, α = 30, v = 0, w = 1.4 | Fail | — |
| u = 0.1, α = 30, v = 0, w = 1.5 | Pass | Pass |
| u = 0.1, α = 30, v = 0, w = 1.95 | Pass | Pass |
| u = 0.1, α = 30, v = 0, w = 2.0 | Pass | Fail |

In Table 3, “—” means “not evaluated”.

As understood from Table 3, a preferable content ratio of the (Ge₁₋ᵤSnᵤTe)_{α}(SbᵥBi_{w}In_{2-v-w}Te₃) recording film 104 in the combination of the recording film and (Al₂O₃)—(Y₂O₃)—(Ta₂O₅) interface films 103, 105 resides in the range as recited below.

(1) 4≦α≦40 and 0≦u≦0.3. If α exceeds 40, the crystallization assist function is degraded and the erasing factor is also reduced at a high linear speed. A part of Ge may be replaced by Sn; however, if the Sn content (u) exceeds 30%, the preservation stability is degraded.

(2) 1.5≦v+w≦1.95. If (v+w) is below 1.5, the crystallization assist function is degraded together with the erasing factor in a higher linear speed range, although preservation stability of the recorded mark is sufficient. If (v+w) exceeds 1.95, the preservation stability is degraded.

As described with reference to the examples, the present invention uses a mixture of Al oxide, Y oxide and Ta oxide for the material of the interface films 103, 105, to thereby improve the crystallization speed of the recording film 104. In addition, by employing a suitable content ratio of these compounds, the improvement of the crystallization speed does not incur reduction of the crystallizing temperature of the recording film 104, whereby the resultant optical disk has a higher preservation stability of the recorded mark and a higher-speed recording capability. The optical disk of the present invention is not limited to the phase change optical disk, and may be applied to other optical disks having a property of changing the optical characteristic thereof upon irradiation of a laser beam, such as a magneto-optical disk.

In the above embodiment, dielectric films including (Al₂O₃)—(Y₂O₃)—(Ta₂O₅) are used as the interface films 103, 105. However, such dielectric films may be used other than for the interface films. For example, such a dielectric film may be used as the protective film 106 shown in FIG. 1. Absence of sulfur in the (Al₂O₃)—(Y₂O₃)—(Ta₂O₅) mixture allows the protective film 106 to suppress sulfuration of Ag in the reflective film 107 which generally includes therein Ag.

Since the above embodiments are described only for examples, the present invention is not limited to the above embodiments and various modifications or alterations can be easily made therefrom by those skilled in the art without departing from the scope of the present invention.

What is claimed is:

1. An optical recording medium comprising a substrate, and a layer structure overlying said substrate, said layer structure including:
a recording film having a property of changing an optical characteristic upon irradiation of a laser beam;
a reflective film for reflecting a laser beam onto said recording film; and
a first dielectric film including therein an aluminum oxide, a yttrium oxide and a tantalum oxide.

2. The optical recording medium according to claim 1, wherein said first dielectric film is in contact with said recording film.

3. The optical recording medium according to claim 2, wherein said first dielectric film is interposed between said recording film and said reflecting film, said reflecting film including Ag.

4. The optical recording medium according to claim 2, wherein said layer structure further includes a second dielectric film formed on a surface of said reflecting film far from said first dielectric film.

5. The optical recording medium according to claim 1, wherein said first dielectric film includes a mixture of Al₂O₃, Y₂O₃ and Ta₂O₅ as a main component thereof.

6. The optical recording medium according to claim 5, wherein x, y and z in the molar percent notation of (Al₂O₃)ₓ(Y₂O₃)_{y}(Ta₂O₅)_{z} satisfy the relationship x+y+z=100, 20≦z≦60 and 5≦x≦30.

7. The optical recording medium according to claim 1, wherein said first dielectric film has a thickness of 3 to 51 nm.

8. The optical recording medium according to claim 1, wherein said recording film includes (Ge₁₋ᵤSnᵤTe)_{α} (SbᵥBi_{w}In_{2-v-w}Te₃), where 0≦u≦0.3, 4≦α≦40, 0≦w≦1.95, and 1.5≦u+w≦1.95.
